(19) United States
(12) Patent Application Publication
(10) Pub. No.: US 2015/0304261 A1
(43) Pub. Date: Oct. 22, 2015

(54) SYSTEMS AND METHODS FOR ECHOING OR REDIRECTING ELECTRONIC MESSAGES IN A CONVERSATION

(71) Applicant: CONVERSEPOINT LLC, Chicago, IL (US)

(72) Inventors: Randall G Menna, Chicago, IL (US); Peter Kelso, Chicago, IL (US)

(73) Assignee: CONVERSEPOINT LLC, Chicago, IL (US)

(21) Appl. No.: 14/648,600

(22) PCT Filed: Nov. 29, 2013
(86) PCT No.: PCT/US13/72506

§ 371 Date: May 29, 2015

Related U.S. Application Data
(60) Provisional application No. 61/732,216, filed on Nov. 30, 2012.

(51) Int. Cl. H04L 12/58; G06Q 50/32; H04L 29/06; G06Q 10/10

(52) U.S. Cl. CPC H04L 51/14; G06Q 10/107; G06Q 50/32; H04L 51/34; H04L 65/4076

(57) ABSTRACT

Systems and methods are provided for echoing or redirecting messages in a conversation between an originating entily and a plurality of recipient entities, According to certain aspects, a facilitating entity determines to echo or redirect an electronic message and identifies an additional entity to which to echo or redirect the electronic message. In some embodiments, the facilitating entity can echo or redirect return messages that are associated with an original message. In redirecting an electronic message, the facilitating entity retrieves the electronic message from a recipient entity and sends the electronic message to an additional entity. The facilitating entity echoes or redirects messages according to various analyses and/or in response to various conditions, situations, and/or the like.

### CROSS-REFERENCE TO RELATED APPLICATION

This international application claims priority to U.S. Provisional Application No. 60/732216, filed Nov. 30, 2012, which is incorporated herein by references in its entirety.

### FIELD

This application generally relates to facilitating electronic messages between and among an originating entity and a plurality of recipient entities in a messaging conversation. In particular, the application relates to platforms and techniques for echoing or redirecting electronic messages to one or more of the plurality of recipient entities or to other entities.

### BACKGROUND

With the increasing prevalence of devices and technology offering electronic messaging and general communication capabilities, individuals are able to more easily and frequently communicate with contacts and other individuals. For example, individuals can send emails, text messages, and other data communications to recipients. With the advancing growth of smart phones, there is an ongoing shift in communications from personal electronic messages to group communication. Particularly, in personal messaging, one party communicates with another party and they engage in an exchange of information. In group communication, one party communicates with a group of individuals, also for the purpose of exchanging information.

However, deficiencies exist in current group communication technologies and protocols. In particular, simply mapping the techniques of personal messaging to a group does not scale in effectiveness and efficiency. For example, getting the right information to the right individuals, ensuring that the right individual is in the conversation, not overloading certain individuals with useless or irrelevant information, and modifying electronic messages into a format or to contain information that can be readily interpreted or understood by the recipients are all challenges that are not addressed by current group communication technologies. Further, the nature of group messaging increases the volume of electronic messages or communications that are sent among the participants of the group communication.

Accordingly, there is an opportunity to develop techniques for making group communication effective, efficient and reliable. In particular, there is an opportunity to develop techniques for ensuring that electronic messages are sent to applicable entities. Further, there is an opportunity to develop techniques for echoing or redirecting an electronic message among entities.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed embodiments, and explain various principles and advantages of those embodiments.

FIG. 1 illustrates an existing data communication pattern in accordance with some embodiments.

FIG. 2A illustrates an exemplary data communication pattern in accordance with some embodiments.

FIG. 2B illustrates an exemplary data communication pattern in accordance with some embodiments.

FIG. 3 illustrates an exemplary application of the electronic message facilitation techniques in accordance with some embodiments.

FIG. 4 illustrates an additional exemplary application of the electronic message facilitation techniques in accordance with some embodiments.

FIG. 5 illustrates an additional exemplary application of the electronic message facilitation techniques in accordance with some embodiments.

FIG. 6 is a block diagram of a device in accordance with some embodiments.

FIG. 7 is a flow diagram depicting message facilitation in accordance with some embodiments.

FIG. 8 is a flow diagram depicting message facilitation in accordance with some embodiments.

### DETAILED DESCRIPTION

The present embodiments are defined by the appended claims. This description summarizes some aspects of the present embodiments and should not be used to limit the claims,

Systems and methods are disclosed for facilitating conversational or group messaging, wherein participant entities can exchange messages and message responses in one or more sets or rounds. Contrary to conventional messaging, the systems and methods as described herein describe a facilitating entity capable of managing the communication of messages among the participant entities of a conversation. In particular, the facilitating entity is capable of echoing or redirecting messages already sent to one entity, to one or more additional entities. Using the facilitating entity, the embodiments create conversation construction patterns that may encompass multiple rounds, and where the electronic message facilitation can be directed according to logic, state, and instruction.

the systems and methods support control of message routing and distribution via identifying sent electronic messages, analyzing the electronic messages, and echoing or redirecting the electronic messages to entities of the conversation who may be unaware of the electronic message being sent. In embodiments, the electronic messages can be original messages or response messages to the original messages. Particularly, logic and other evaluative techniques can be used to analyze individual and collected messages, message data, and message metadata according to predefined criteria and other parameters. The systems and methods can advantageously make group messaging techniques more effective, efficient and reliable. For example, the facilitating entity can echo or redirect messages sent by one entity to other entities such that the other entities are aware of the existence and the content of the electronic messages. It should be appreciated that the electronic messages in the conversation can be used in any context or for any purpose such as, for example, eliciting open or enumerated responses from recipient entities, communicating information or data, and/or other contexts and purposes. It should be appreciated that the entities as discussed herein can be a human, a system, a system acting on behalf of a human, a corporation, a company, an enterprise, or other types of entities.

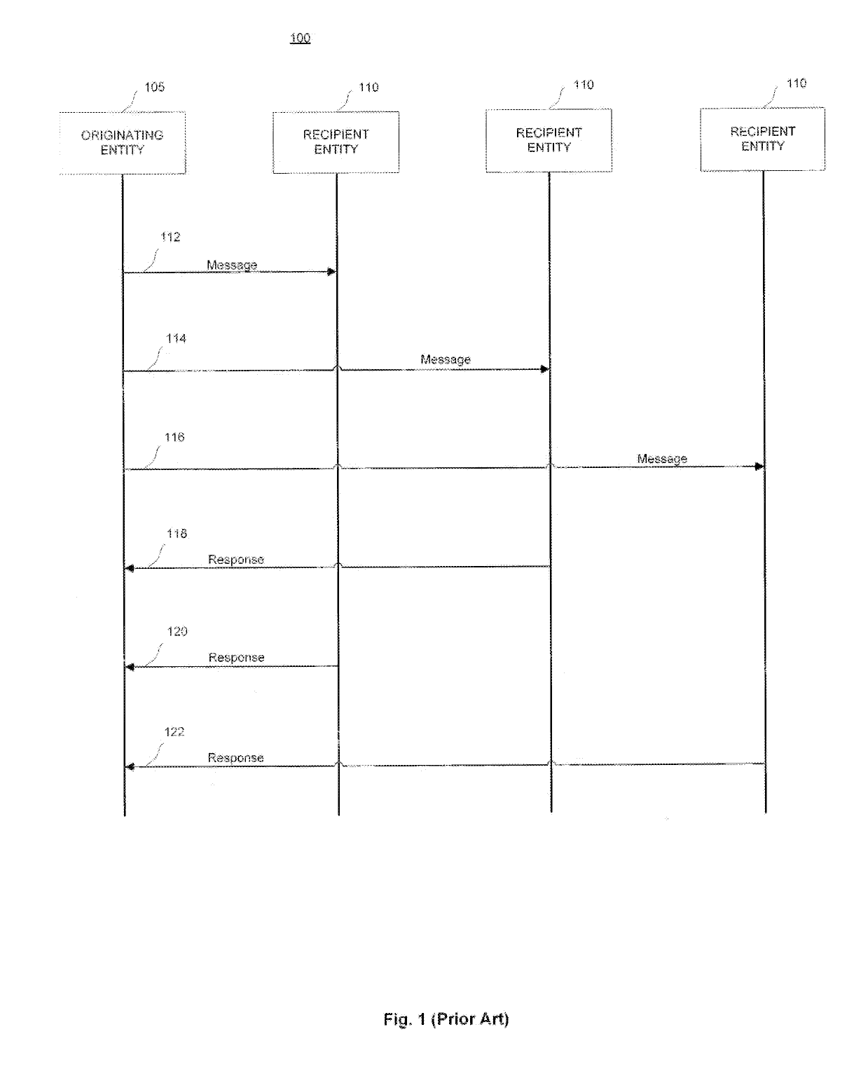

Referring to FIG. 1, depicted is a currently existing communication technology pattern 100 related to sending an electronic message to a plurality of recipient entities. As shown in FIG. 1, the pattern 100 includes an originating entity 105 and three (3) recipient entities 110, wherein the originating entity 105 has an electronic message that it intends to send to each of the recipient entities 130.

The originating entity 105 sends 112, 114, 116 the electronic message to each of the recipient entities 110. Particularly, the electronic message that is received by the recipient entities 110 is the same message that is sent by the originating entity 105, without any modification of content associated with the electronic message. As shown in FIG. 1, the originating entity 105 receives 118, 120, 122 various responses from each of the recipient entities 110. For example, the responses can be direct responses to the electronic message sent to the recipient entities 110.

However, there are drawbacks to the existing communication pattern 100 as detailed in FIG. 1. Particularly, in some cases, an additional recipient entity who may benefit from or may otherwise be interested in receiving the electronic message may not know that the electronic message has been sent or may not have access to the content of the electronic message. In some other cases, a recipient entity may receive an electronic message that needs attention to which the recipient entity is not able to promptly respond. In still further cases, a recipient entity who has received an electronic message may benefit from or may otherwise be interested in receiving a return message associated with the electronic message that was sent by an additional recipient entity who also received the electronic message.

Accordingly, there is an opportunity to echo, redirect, or otherwise send messages among a plurality of recipient entities. In this regard, the present embodiments increase the visibility of the electronic messages among the recipient entities, and inform the recipient entities of information or data that the recipient entitles otherwise are not able to be aware of or receive.

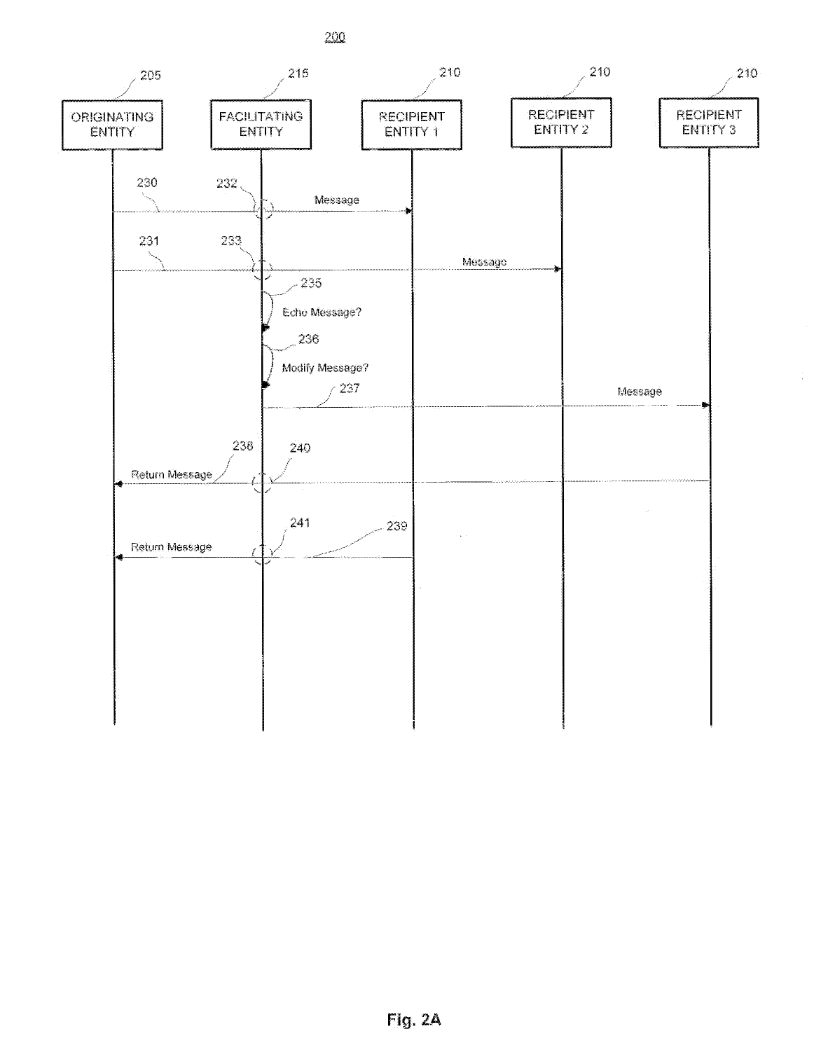

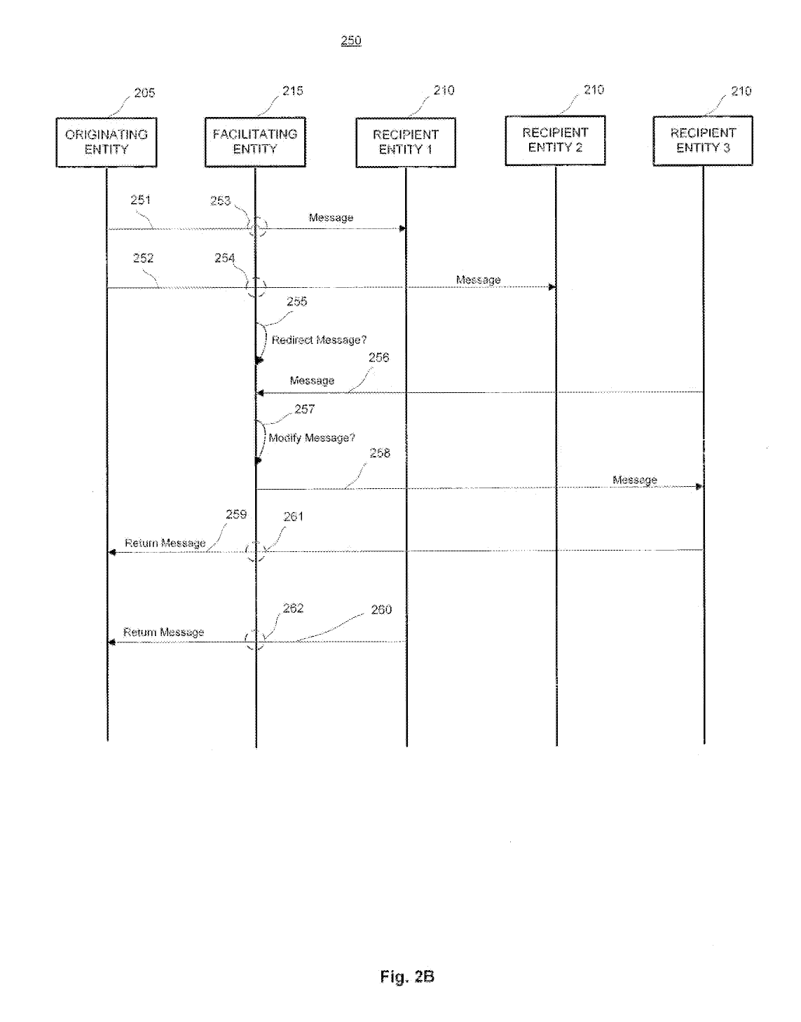

Referring to FIG. 2A, depicted is a communication pattern 200 detailing the present embodiments. Similar to the communication pattern 100 of FIG. 1, the communication pattern 200 includes an originating entity 205 and three (3) recipient entities 210. The communication pattern 200 further includes a facilitating entity 215 capable of facilitating messages between and among the originating entity 205 and the recipient entities 210. It should be understood that the facilitating entity 215 can include any combination of hardware and software capable of performing the functionalities as discussed herein. For example, the facilitating entity 215 can be any type of computer, server, or the like. Further, it should be understood drat a user can interface with the facilitating entity 215 to provide input for any of the functionalities as discussed herein.

As shown in FIG. 2A, the originating entity 205 can send (230, 231) an electronic message to recipient entity (1) 210 and recipient entity (2) 210. In embodiments, the electronic message can be any type of data capable of being communicated such as, for example, e-mails, text messages (e.g., SMS, MMS, etc.), voice-to-text messages, electronic documents, or other data types. Further, the electronic message can include content that can be any combination of metadata, body content, header information, and/or the like. Further, the electronic message can have an associated list or information that identifies recipients to which the electronic message is intended. For example, the list can indicate phone numbers, email addresses, or other identifying information of the intended recipients. Further still, the individual messages received by each of the recipient entities 210 can include the same or different content. In embodiments, the “reply” metadata of the electronic message can specify the facilitating entity 215. Particularly, when any of the recipient entities 210 responds to the electronic message, the resulting responses can be populated with an address (e.g., an email address) or other identifying information of the facilitating entity 215. In this regard, in addition to the recipient entities 210 sending responses to the originating entity 205, the recipient entities 210 can send responses to the facilitating entity 215.

According to embodiments, the facilitating entity 215 can detect (232, 233) that the originating entity 205 has sent the electronic message to the two recipient entities 210, or that the electronic message has been received by the two recipient entities 210 from the originating entity 205. In one embodiment, this can be earned out as follows: The facilitating entity 215 can monitor the protocol used to deliver message to the recipient entities 210. The facilitating entity 215 or originating entity 205 can also embed downloadable elements into messages such that the act of their downloading or sending indicates reception of the electronic message. The facilitating entity can also monitor meta-data used by system and/or other system software used by recipient to indicate that a message has been sent to the recipient entities 210/received by the recipient entities 210. The recipient entities 210 can also have software running thereon to report back to the facilitating computer that an electronic message has been received by the recipient entities 210 by (a) monitoring changes in user interface used to display messages: (b) monitoring changes in storage (file or system memory) used to hold messages; (c) triggered that receipt has occurred by another software system within the recipient entities 210; and/or (d) the recipient entities 210 monitoring the protocol used to receive messages on recipients entities 210.

Further, in some cases, the facilitating entity 215 can receive the electronic message directly from the originating entity 205 and send the electronic message to the two recipient entities 210. In either case, the facilitating entity 215 can identify content of the electronic message and the intended recipients of the electronic message, and can store or otherwise record this information. In embodiments, the facilitating entity 215 can perform any necessary modifications to the electronic message before sending the electronic message to the recipient entities 210.

As shown in FIG. 2A, the facilitating entity 215 can determine 235 whether to echo the electronic message. More particularly, the facilitating entity 215 can echo an electronic message by sending the electronic message to a recipient entity that has not yet received the electronic message. In some cases, the facilitating entity 215 can determine that one of the recipient entities that did not receive the electronic message should have received the electronic message. For example, the facilitating entity 215 can analyze the content of the electronic message to determine that the electronic message is more relevant to one or more recipient entities that did not receive the electronic message. Further, for example, the facilitating entity 215 can analyze the electronic message and determine that one or more of the recipient entities was inadvertently removed, such as in a group email chain. In embodiments, the facilitating entity 215 can receive an input from a user that requests dial the facilitating entity 215 echo the electronic message to one or more recipient entities that did not receive the electronic message. In the same or other embodiments, the determination 235 can be done in various ways. For example, the recipient entities 210 or facilitating entity 215 can (a) evaluate the electronic message using explicit rules attached to original message at the time the electronic message was created; (b) evaluate implicit rules that are configured for the particular sender of the message, particular recipient of the message, or particular organization of which the entities 210, 215 are members; (e) evaluate the meta data of other recipients of the electronic message, the meta data internal to the system, the meta data from external systems, and/or time information relating to when the message was created, to the message hold time, and/or to the message delivery time; (d) receive input from message creator after message delivery, which is then used to make the determination; and/or (e) receive input from other recipients after message delivery, which is then used to make the determination. It should be appreciated that the facilitating entity 215 can determine to echo the electronic message according to any situation, circumstance, and/or the like.

In embodiments, the facilitating entity 215 can determine 236 whether to modify the electronic message. The same or similar criteria or sub-process can be used to make the modification determination 236 as the echo determination 235. In one embodiment, the facilitating entity 215 can determine to modify the electronic message if some of the content in the electronic message is sensitive or confidential. Further, in some cases, the facilitating entity 215 can modify the electronic message by including, in the electronic message, an indication of which recipient entities have already received the electronic message. It should be appreciated that the facilitating entity 215 can determine to modify the electronic message according to any situation, circumstance, and/or the like.

The facilitating entity 215 can send (echo) 237 the electronic message to one or more recipient entities that did not originally receive the electronic message. For example, as shown in FIG. 2A, the facilitating entity 215 echoes the electronic message to recipient entity (3) 210. In response to receiving the electronic message, the respective recipient entities 210 can determine if and how to respond to the electronic message. As shown in FIG. 2A, the recipient entities (1) and (3) 210 can compose and send (238, 239) return messages to the originating entity 205. For example, if the electronic message includes a question, the return messages can include answers or responses to the question. In one embodiment, the return message can include the original message that the originating entity 205 sent to the recipient entities 210. In some embodiments, one or more of the recipient entities 210 may not send a return message. For example, one of the recipient entities 210 may not access the electronic message or may not choose to respond to the electronic message, among other situations. In further embodiments, the facilitating entity 215 can detect (240, 241) that the recipient entities 210 have sent the return message to the originating entity 205. Further, in some cases, the facilitating entity 215 can receive the return message from the applicable recipient entities 210 and send the return messages to the originating entity 205. In embodiments, the facilitating entity 215 can identify content of the return messages and can store or otherwise record this information.

Referring to FIG. 2B, depicted is a communication pattern 250 detailing the present embodiments. Similar to the communication pattern 100 of FIG. 1, the communication pattern 250 includes the originating entity 205 and three (3) recipient entities 210. The communication pattern 250 further includes the facilitating entity 215 capable of facilitating messages between and among the originating entity 205 and the recipient entities 210. It should be understood that the facilitating entity 215 can include any combination of hardware and software capable of performing the functionalities as discussed herein. For example, the facilitating entity 215 can be any type of computer, server, or the like. Further, it should be understood that a user can interface with the facilitating entity 215 to provide input for any of the functionalities as discussed herein.

As shown in FIG. 2B, the originating entity 205 can send (251, 252) an electronic message to recipient entity (1) 210 and recipient entity (2) 210. In embodiments, the electronic message can be any type of data capable of being communicated such as, for example, e-mails, text messages (e.g., SMS, MMS, etc.), voice-to-text messages, electronic documents, or other data types. Further, the electronic message can include content that can be any combination of metadata, body content, header information, and/or the like. Further, the electronic message can have an associated list or information that Identifies recipients to which the electronic message is intended. For example, the list can indicate phone numbers, email addresses, or other identifying information of the intended recipients. Further still, the individual messages received by each of the recipient entities 210 can include the same or different content. In embodiments, the “reply” metadata of the electronic message can specify the facilitating entity 215. Particularly, when any of the recipient entities 210 responds to the electronic message, the resulting responses can be populated with an address (e.g., an email address) or other identifying information of the facilitating entity 215. In this regard, in addition to the recipient entities 210 sending responses to the originating entity 205, the recipient entities 210 can send responses to the facilitating entity 215.

According to embodiments, the facilitating entity 215 can detect (253, 254) that the originating entity 205 has sent the electronic message to the two recipient entities 210. Further, in some eases, the facilitating entity 215 can receive the electronic message from the originating entity 205 and send the electronic message to the two recipient entities 210. In either case, the facilitating entity 215 can identify content of the electronic message and the intended recipients of the electronic message, and can store or otherwise record this information. In embodiments, the facilitating entity 215 can perform any necessary modifications to the electronic message before sending the electronic message to the recipient entities 210.

As shown in FIG. 2B, the facilitating entity 215 can determine 255 whether to redirect the electronic message. More particularly, the facilitating entity 215 can redirect the electronic message by retrieving the electronic message from one or more of the recipient entities 210 that has already received the electronic message, and sending the electronic message to another of the recipient entities 210 that has not received the electronic message. In embodiments, the facilitating entity 215 can remove the electronic message from an electronic inbox of one of the recipient entities 210 and forward the electronic message to an electronic inbox of another of the recipient entities 210.

In some cases, the facilitating entity 215 can determine to redirect the electronic message by determining that one of the recipient entities that did not receive the electronic message should have received the electronic message. For example, the facilitating entity 215 can analyze the content of the electronic message to determine that the electronic message is more relevant to one or more recipient entities that did not receive the electronic message. Further, for example, the facilitating entity 215 can analyze the electronic message and determine that one or more of the recipient entities was inadvertently removed and/or one or more of the recipient entities was inadvertently added, such as in a group email chain. In embodiments, the facilitating entity 215 can receive an input from a user that requests that the facilitating entity 215 redirect the electronic message to one or more recipient entities that did not receive the electronic message. It should be appreciated that the facilitating entity 215 can determine to redirect the electronic message according to any situation, circumstance, and/or the like.

In embodiments, the facilitating entity 215 can determine 257 whether to modify the electronic message. For example, the facilitating entity 215 can determine to modify the electronic message if some of the content in the electronic message is sensitive or confidential. Further, in some cases, the facilitating entity 215 can modify the electronic message by including, in the electronic message, an indication of which recipient entities have already received the electronic message. It should be appreciated that the facilitating entity 215 can determine to modify the electronic message according to any convention, situation, circumstance, and/or the like.

The facilitating entity 215 can send (redirect) 258 the electronic message to one or more recipient entitles that did not originally receive the electronic message. For example, as shown in FIG. 2B, the facilitating entity 215 redirects the electronic message to recipient entity (3) 210. In response to receiving the electronic message, the respective recipient entities 210 can determine if and how to respond to the electronic message. As shown in FIG. 2B, the recipient entities (1) and (3) 210 can compose and send (259, 260) return messages to the originating entity 205. For example, if the electronic message includes a question, the return messages can include answers or responses to the question. In one embodiment, the return message can include the original message that the originating entity 205 sent to the recipient entities 210. In some embodiments, one or more of the recipient entities 210 may not send a return message. For example, one of the recipient entities 210 may not access the electronic message or may not choose to respond to the electronic message, among other situations. In further embodiments, the facilitating entity 215 can detect (261, 262) that the recipient entities 210 have sent the return message to the originating entity 205. Further, in some cases, the facilitating entity 215 can receive the return message from the applicable recipient entities 210 and send the return messages to the originating entity 205. In embodiments, the facilitating entity 215 can identify content of the return messages and can store or otherwise record this information.

It should be appreciated that the facilitating entity 215 can determine to echo or redirect any message at any point in time, from or to any recipient entity, according to any situation or circumstance. For example, the facilitating entity 215 can determine to echo or redirect the electronic message by determining that one of the recipient entities has not viewed or accessed the electronic message within a predetermined amount of time, or that one of the recipient entities is not well suited or able to respond to the electronic message. In some cases, the facilitating entity 215 can determine to echo or redirect the electronic message in response to a predetermined or predefined criteria associated with the electronic message or with any of the entitles being met. For example, the predetermined or predefined criteria can be met if a certain amount of recipient entities fails to respond to an electronic message within a set amount of time. For further example, the predetermined or predefined criteria can be met if the content of one of the return messages indicates a fulfillment of a threshold value. In other cases, in determining whether to echo or redirect the electronic message, the facilitating entity 215 can perform a lexical analysis on the electronic message. In embodiments, the facilitating entity 215 can echo or redirect an electronic message to an entity outside of the conversation.

Further, it should be appreciated that the facilitating entity 215 can echo return messages sent by any of the recipient entities 210. In this case, in addition to the applicable recipient entity sending the response message to the originating entity 205, the facilitating entity 215 can echo the return message to an additional recipient entity or an entity outside of the conversation. Particularly, the originating entity 205 can send an electronic message to the recipient entities 210 and, when one of the recipient entities 210 sends a return message associated with the electronic message, the facilitating entity 215 can determine whether to echo the return message according to any situation, circumstance, or the like. For example, the facilitating entity 215 can determine to echo a return message to an additional entity to inform the additional entity of the content of the return message.

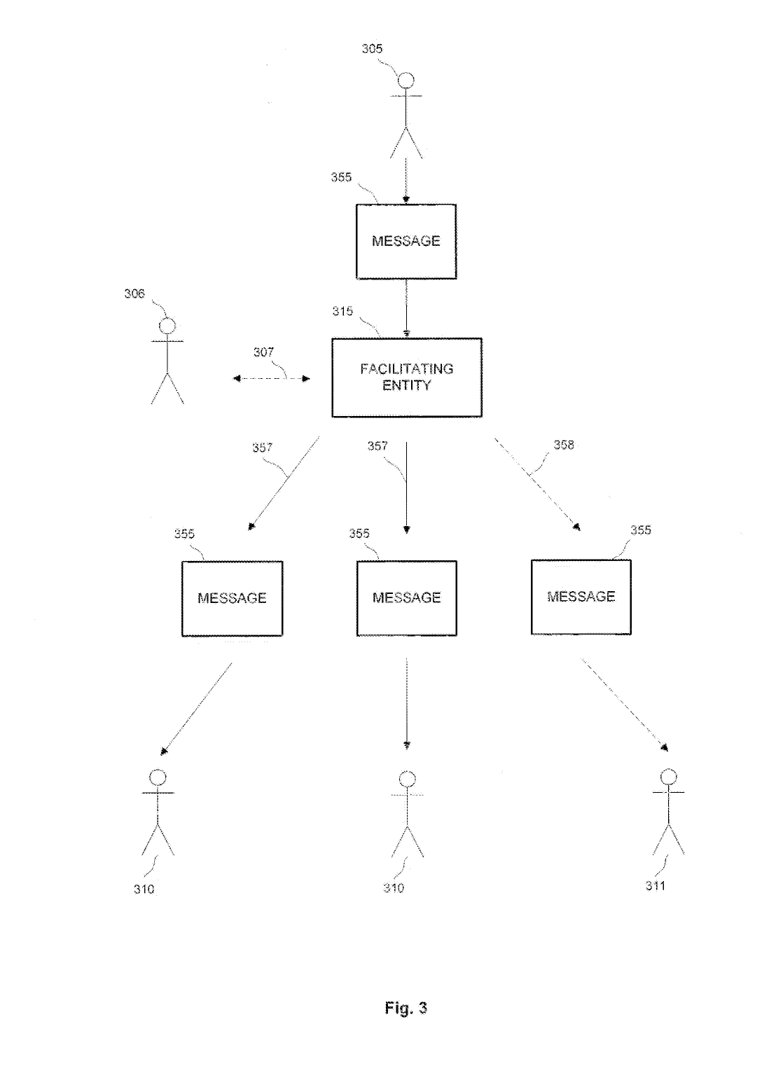

Referring to FIG. 3, depicted is an exemplary application of the functionalities as described herein. In particular, FIG. 3 depicts a situation where a user 306 associated with a facilitating entity 315 facilitates an echoing of an electronic message.

As shown in FIG. 3, an originating entity 305 can create or compose an electronic message 355 to be sent to a plurality of recipient entities 310. The electronic message can comprise any type of content or information, and can indicate each of the plurality of recipient entities 310. As shown in FIG. 3, the originating entity 305 can send the electronic message 355 to the facilitating entity 315, and the facilitating entity 315 can send (357) the electronic message 355 to the two recipient entities 310. In embodiments, the originating entity 305 can send the electronic message 355 directly to the recipient entities 310.

The user 306 can interact or otherwise communicate (307) with the facilitating entity 315, and specify any other recipient entities who should receive the electronic message 355. Particularly, the user 306 can specify the parameters for echoing or redirecting of the electronic message 355. In embodiments as shown, in FIG. 3, the user 306 can instruct the facilitating entity 315 to echo the electronic message 355 to an additional recipient entity 311. In response to receiving the instruction, the facilitating entity 315 can echo (358), or send, the electronic message 355 to the additional recipient entity 311. In embodiments, the facilitating entity 315 can modify the electronic message 355 prior to echoing the electronic message 355 to the additional recipient entity 311. Further, in embodiments, any of the plurality of recipient entities 310 and the additional recipient entity 311 can send a return message to the originating entity 305.

In the exemplary application as shown in FIG. 3, the user 306 can control which recipient entities receive the electronic message 355, even after the plurality of original recipient entities 310 have received the electronic message 355. In this regard, the user 306 can offer additional insight as to which recipient entities are to receive the electronic message 355. For example, the originating entity 305 may not know or be aware of a recipient entity who is most relevant to the electronic message 355, and the user 306 can identify the additional recipient entity 311 as that which is most relevant to the electronic message 355. It should be appreciated that other benefits of the user 306, in combination with the facilitating entity 315, facilitating the echoing of any messages are envisioned.

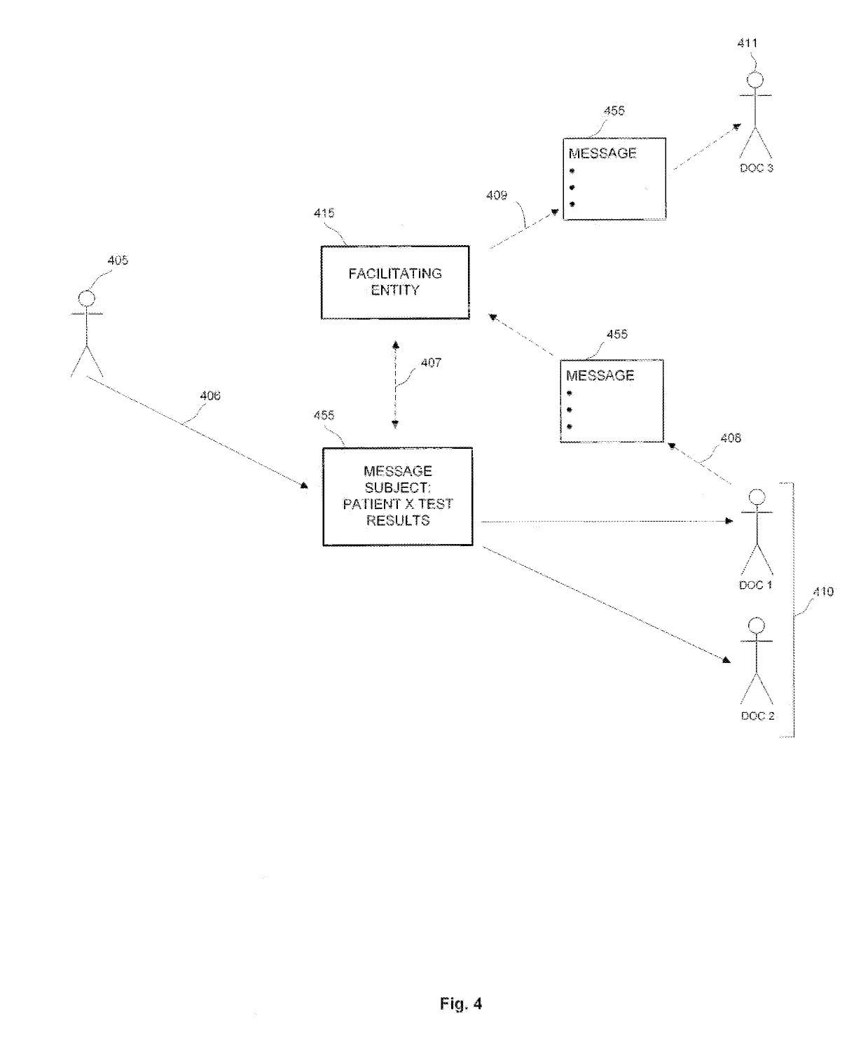

Referring to FIG. 4, depicted is an exemplary application of the functionalities as described herein. In particular, FIG. 4 depicts a situation where a facilitating entity 415 redirects an electronic message from one recipient entity to another recipient entity.

As shown in FIG. 4, an originating entity 405 can create or compose an electronic message 455 to be sent to a plurality of recipient entities 410. More particularly, the electronic message 455 can include an electronic message body (as shown: “Patient X Test Results”). Although not shown in FIG. 4, the electronic message 455 can further include the actual test results for Patient X. Further, the recipient entities 410 can represent two doctors or medical personnel (e.g., “Doc 1” and “Doc 2”) who the originating entity 405 believes are treating or are otherwise associated with Patient X. Accordingly, the originating entity 405 may desire to send test results associated with Patient X to the doctors associated with the treatment of Patient X.

As shown in FIG. 4, the originating entity 405 can send (406) the electronic message 455 to the recipient entities 410. In one embodiment, the “reply” metadata of the electronic message 455 can specify the facilitating entity 415. Particularly, when any of the recipient entities 410 responds to the electronic message 455, the resulting responses can be populated with an address (e.g., an email address) or other identifying information of the facilitating entity 415.

In one embodiment, the facilitating entity can detect (407) that the originating entity 405 has sent the electronic message 455 to the recipient entities 410. Particularly, the facilitating entity 415 can identify content of the electronic message 455 and the intended recipients 410 of the electronic message 455, and can store or otherwise record this information. In other embodiments, the originating entity 405 can send the electronic message 455 to the facilitating entity 415, which can send the electronic message 455 to the recipient entities 410. In this case, the facilitating entity 415 can perform any necessary modifications to the electronic message before sending the electronic message to the recipient entities 410.

According to embodiments, the facilitating entity 415 can determine that the electronic message 455 received by one of the recipient entities 410 needs to be redirected to an additional recipient entity 411. For example, as shown in FIG. 4, the facilitating entity 415 can determine that “Doc 1” is not treating Patient X and should therefore not receive the electronic message 455 including the test results for Patient X. Further, for example as shown in FIG. 4, the facilitating entity 415 can determine that “Doc 3” (411) is treating Patient X and should therefore receive the electronic message 455 including the test results for Patient X.

As shown in FIG. 4, the facilitating entity 415 can retrieve (408) the electronic message 455 from “Doc 1” (410). In some cases, the facilitating entity 415 can remove the electronic message 455 from an electronic inbox associated with “Doc 1,” regardless of whether Doc 1 has read or accessed the electronic message 455. The facilitating entity 415 can further send (409) the electronic message 455 to “Doc 3” (411). Although not shown in FIG. 4, the recipient entities 410 who have access to the electronic message (“Doc 2” and “Doc 3”) can respond to the electronic message 455 by sending return messages to the originating entity 405.

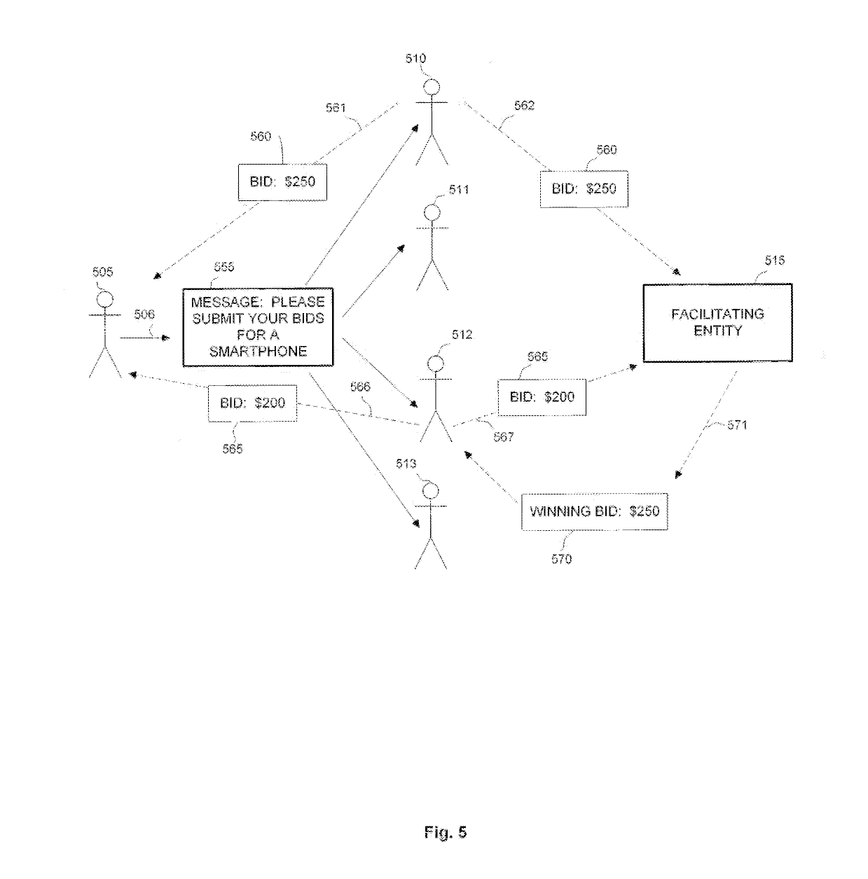

Referring to FIG. 5, depicted is an additional exemplary application of the functionalities as described herein. In particular, FIG. 5 depicts a situation where a facilitating entity 515 modifies a return message before echoing the return message to a recipient entity.

As shown in FIG. 5, the originating entity 505 can create or compose an electronic message 555 to be sent to a plurality of recipient entities 510, 511, 512, 513. In embodiments as shown in FIG. 5, the electronic message 555 includes an electronic message body that elicits bids for a product from the plurality of recipient entities 510, 513, 512, 513 (as shown: “Please submit your bids for a smartphone”). Particularly, the originating entity 505 may want to receive bids from the recipient entities 510, 511, 512, 513 to determine which is willing to pay the highest amount for the product.

In embodiments, the originating entity 505 can specify the recipient entities 510, 511, 512, 513 to which to send the electronic message 555, and can send (506) the electronic message 555 directly to the recipient entities 510, 511, 512, 513, as illustrated in FIG. 5. In some embodiments, the originating entity 505 can send the electronic message 555 to the recipient entities 510, 511, 512, 513 via the facilitating entity 515. Upon receipt of the electronic message 555, one or more of the recipient entities 510, 511, 512, 513 can respond to the electronic message by sending return messages.

As shown in FIG. 5, the recipient entities 510, 512 can send (561, 566) return messages 560, 565 to the originating entity 505. Particularly, the return messages 560, 565 can indicate bids for the product identified in the electronic message 555 (as shown: message 560 is a bid for $250 and message 565 is a bid for $200). According to embodiments, the facilitating entity 515 can detect that the recipient entities 510, 512 have sent the return messages 560, 565 to the originating entity 505. In these embodiments, the facilitating entity 515 can identify the content of the return messages 560, 565 (i.e., the bid amounts). In some embodiments, the recipient entitles 510, 512 can send (562, 567) the return messages 560, 565 directly to the facilitating entity 515 in addition to sending the return messages 560, 565 to the originating entity 505.

According to embodiments, the facilitating entity 515 can examine the return messages 560, 565 to determine a winning bid (in this case: the bid for $250). Further, the facilitating entity 515 can generate a new return message, or otherwise modify one of the return messages 560, 565 to send to the one or more of the recipient entities 510, 512. As shown in FIG. 5, the facilitating entity 515 can generate a modified return message 570 that indicates the winning bid (as shown: “Winning Bid: $250”) and send (571) the modified return message 570 to the recipient entity 512. Particularly, by sending the modified return message 570 to the recipient, entity 512 that did not have the highest bid, the facilitating entity 515 informs the recipient entity 512 of the winning bid amount. In embodiments, the facilitating entity 515 can also send the modified return message 570 to one or more of the other recipient entities 510, 511, 513.

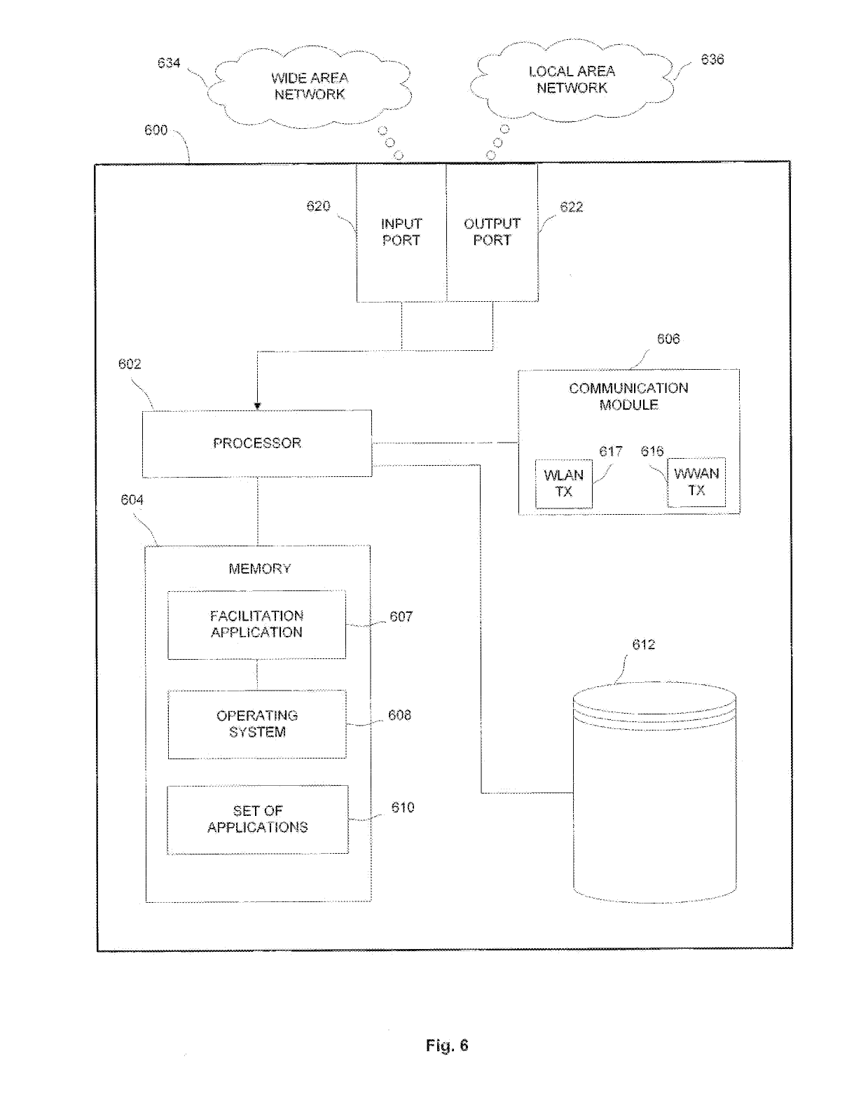

Referring to FIG. 6, depicted is an exemplary server 600 and components thereof. More particularly, the server 600 can be a combination of hardware and software components associated with the facilitating entity as discussed herein. It should be appreciated that FIG. 6 represents a generalized schematic illustration and that other hardware and software components can be added or existing components can be removed or modified.

As shown in FIG. 6, the server 600 can comprise a set of ports that can receive input signals or data from, or output signals or data to, other components of a communication environment, such as the originating entity 205 and the recipient entities 210 as discussed with respect to FIG. 2. More particularly, an input port 620 can receive cellular or other types of data from a wide area network 634 (such as various private or public networks) or a local area network 636 (such as a wireless local area network (WLAN), and an output port 622 can output data to the wide area network 634 or the local area network 636. Although not shown in FIG. 6, the systems and methods envision other types of wired or wireless networks through which data can be communicated.

The server 600 can further comprise a processor(s) 602 communicating with a memory 604, such as electronic random access memory (RAM), or other forms of transitory or non-transitory computer readable storage mediums, operating under control of or in conjunction with an operating system 608. The operating system 608 can be my commercial, open-source, or proprietary operating system or platform. The processor 602 can communicate with a database 612, such as a database stored on a local hard drive. While illustrated as a local database in the server 600, the database 612 can be separate from the server 600.

The processor 602 can further communicate with a communication module 606, such as a wired or wireless data connection, which in turn communicates with the wide area network 634 and the local area network 636. In particular, the communication module 606 can comprise a WWAN transceiver 616 capable of communicating with the wide area network 634 and a WLAN transceiver 617 capable of communicating with the local area network 636. The set of ports 620, 622 of the server 600 can use the components of the communication module 606 to connect to any of the entities as discussed herein. For example, the input port 620 can receive an electronic message from the originating entity 205 via the WWAN transceiver 616, and the output port 622 can send the electronic message to the recipient entities 610 via the WWAN transceiver 616. The processor 602 can also communicate with a set of applications 610 that can be configured to execute control logic and perform data processing to perform the functions and techniques as discussed herein. For example, the set of applications 610 can comprise a facilitation application 607 that can support the functionalities of the electronic message facilitation, as described herein. It should be appreciated that other applications 610 and functionalities thereof are envisioned.

While FIG. 6 illustrates the server 600 as a standalone system using a combination of hardware and software, the components of the server 600 can also be implemented as a software application or program capable of being executed by a conventional computer platform. Likewise, the components of the server 600 can also be implemented as a software module or program module capable of being incorporated in other software applications and programs. In either case, the components of the server 600 can be implemented in any type of conventional proprietary or open-source computer language.

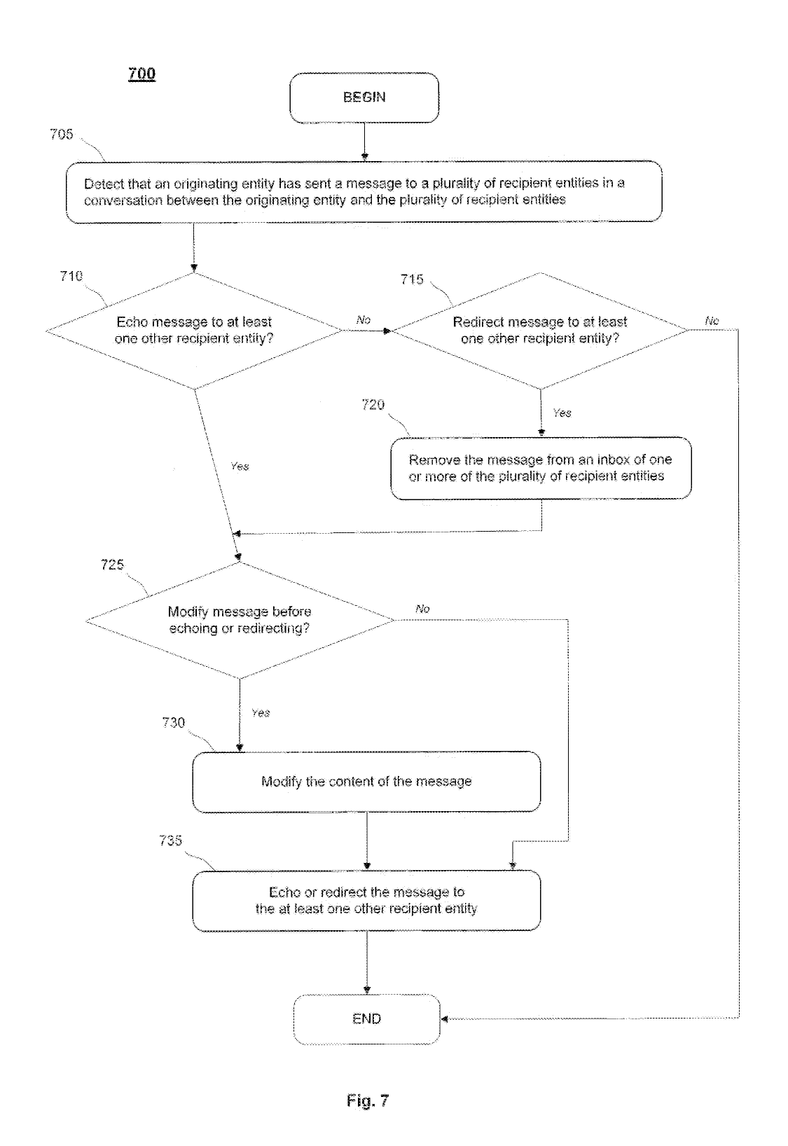

FIG. 7 is a flowchart of a method 700 for a facilitating entity (such as the facilitating entity 215 as discussed with respect to FIG. 2) to echo or redirect messages to additional recipient entities. More particularly, the method 700 relates to the facilitating entity echoing or redirecting, to an additional recipient entity, an electronic message already sent by an originating entity to a plurality of recipient entities.

The method 700 begins with the facilitating entity detecting 705 that an originating entity has sent an electronic message to a plurality of recipient entities in a conversation between the originating entity and the plurality of recipient entities. In some embodiments, the facilitating entity can receive the electronic message from the originating entity and send the electronic message to the plurality of recipient entities. The facilitating entity determines 710 whether to echo the electronic message to at least one other recipient entity. If the facilitating entity determines to not echo the electronic message (“NO”), the facilitating entity determines 715 whether to redirect the electronic message to at least one other recipient entities. In some embodiments, the facilitating entity can make these determinations by analyzing the electronic message or according to other parameters, conditions, or thresholds, as discussed herein. In other embodiments, a user can interface with the facilitating entity to instruct the facilitating entity to echo or redirect the electronic message.

If the facilitating entity determines to not redirect the electronic message (“NO”), then processing can end, repeat, or proceed to another step. If the facilitating entity determines to redirect the electronic message (“YES”), the facilitating entity removes 720 the electronic message from an electronic inbox of one or more of the plurality of recipient entities. Particularly, the facilitating removes the electronic message such that the one or more recipient entities no longer have access to the electronic message. After the facilitating entity removes the electronic message or if the facilitating entity determines to echo the electronic message (“YES”), the facilitating entity determines 725 whether to modify the electronic message before echoing or redirecting. In embodiments, the facilitating entity can determine to modify the electronic message based on any type of parameter, condition, or threshold, as discussed herein.

If the facilitating entity determines to modify the electronic message (“YES”), the facilitating entity modifies 730 the content of the electronic message according to any convention. In embodiments, the facilitating entity can modify the electronic message based on an analysis of the electronic message. After the facilitating entity modifies the content of if the facilitating entity determines to not modify the electronic message (“NO”), the facilitating entity echoes or redirects 735 the electronic message to the at least one other recipient entity.

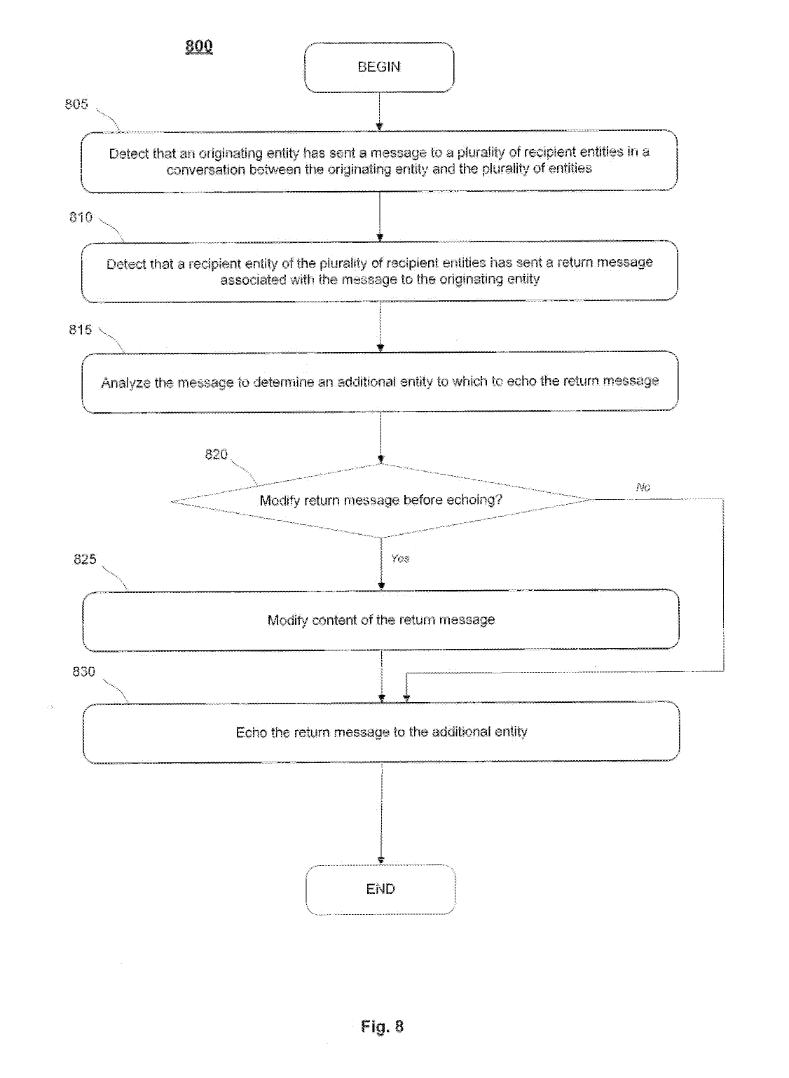

FIG. 8 is a flowchart of a method 800 for a facilitating entity (such as the facilitating entity 215 as discussed with respect to FIG. 2) to echo return messages to additional entities. More particularly, the method 800 relates to the facilitating entity echoing, to an additional entity, a return message that is sent by a recipient entity to an originating entity.

The method 800 begins with the facilitating entity detecting 805 that an originating entity has sent an electronic message to a plurality of recipient entities in a conversation between the originating entity and the plurality of recipient entities. In some embodiments, the facilitating entity can receive the electronic message from the originating entity and send the electronic message to the plurality of recipient entitles. The facilitating entity further detects 810 that a recipient entity of the plurality of recipient entities has sent a return messages associated with the electronic message to the originating entity. In some embodiments, the recipient entity can also send the return message to the facilitating entity.

The facilitating entity analyzes 815 the electronic message to determine an additional entity to which to echo (i.e., send) the return message. In embodiments, the additional entity can be another of the plurality of recipient entities or an entity outside of the conversation. Further, it should be appreciated that the facilitating entity can analyze the electronic message according to any parameters, conditions, or thresholds, as discussed herein. The facilitating entity determines 820 whether to modify the return message before echoing. In embodiments, the facilitating entity can determine to modify the electronic message based on any type of parameter, condition, or threshold, as discussed herein.

If the facilitating entity determines to modify the electronic message (“YES”), the facilitating entity modifies 825 the content of the electronic message according to any convention. In embodiments, the facilitating entity can modify the electronic message based on an analysis of the electronic message. After the facilitating entity modifies the content of if the facilitating entity determines to not modify the electronic message (“NO”), the facilitating entity echoes 830 the electronic message to the additional entity.

Thus, it should be clear from the preceding disclosure that the system and method effectively and efficiently manages an electronic message exchange between an originating entity and a plurality of recipient entities. The system and method advantageously allows a facilitating entity to echo or redirect messages to additional entities who would not otherwise receive the electronic message and the content therein. Further, the system and method advantageously helps entities of a conversation stay informed of the various communications and information sent among the other entities of the conversation.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible In light of the above teachings. The embodiment(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, as may be amended during the pendency of this application for patent, and all equivalents thereof, when interpreted in accordance with the breadth to which they are fairly, legally and equitably entitled.

1. A method of managing messaging within a conversation between art originating entity and a plurality of recipient entities, the method comprising:
detecting, by a first computer, that each of the plurality of recipient entities has received an electronic message sent from the originating entity;
monitoring, by the first computer, the receipt of the electronic message by each of the recipient entities to determine that the electronic message is to be sent to an additional recipient entity; and
based on the monitoring, sending the electronic message to the additional recipient entity.

2. The method of claim 1, wherein sending the electronic message to the additional recipient entity comprises:
removing the electronic message from an electronic inbox of one of the plurality of recipient entities; and
forwarding the electronic message to an additional electronic inbox of the additional recipient entity.

3. The method of claim 1, wherein monitoring the receipt of the electronic message by each of the recipient entitles comprises:
determining that one of the plurality of recipient entities has not viewed the electronic message; and
in response to the determining, identifying the additional recipient entity.

4. The method of claim 1, wherein monitoring the receipt of the electronic message by the recipient entity comprises:
determining that one of the recipient entities is not relevant to the electronic message; and
in response to the determining, identifying the additional recipient entity, wherein the additional recipient entity is relevant to the electronic message.

5. The method of claim 1, wherein sending the electronic message to the additional recipient entity comprises:
analyzing the electronic message to determine how to modify content associated with the electronic message;
modifying the content associated with the electronic message according to the analyzing; and
sending the electronic message with the content that was modified to the additional recipient entity.

6. The method of claim 1, further comprising:
detecting that the additional recipient entity has sent a return message to the originating entity;
analyzing the return message to determine that the return message is to be sent to a further recipient entity; and
in response to the analyzing, sending the return message to the further recipient entity.

7. The method of claim 1, wherein monitoring the receipt of the electronic message by each of the recipient entities comprises performing a lexical analysis on the electronic message to determine that the electronic message is to be sent to the additional recipient entity.

8. A method of managing messaging within a conversation between an originating entity and a plurality of recipient entities, the method comprising:
detecting, by a first computer, that a recipient entity of the plurality of recipient entities has sent a return message to the originating entity, the return message associated with an electronic message sent by the originating entity to the plurality of recipient entities;
in response to the detecting, analyzing, by the first computer, the return message to determine an additional recipient entity of the plurality of recipient entities or an entity outside of the conversation to which to send the return message; and
based on the analyzing, sending the return message to the additional recipient entity or the entity outside of the conversation.

9. The method of claim 8, wherein sending the return message comprises:
analyzing the return message to determine how to modify content associated with the return message;
modifying the content associated with the return message according to the analyzing; and
sending the return message with the content that was modified to the additional recipient entity or the entity outside of the conversation.

10. The method of claim 8, wherein analyzing the return message comprises:
analyzing the return message to identify which of the additional recipient entity or the entity outside of the conversation is relevant to the conversation.

11. The method of claim 8, wherein the electronic message comprises a bid requirement and the return message comprises a bid from the recipient entity, and wherein analyzing the return message comprises:
identifying an additional bid sent by another recipient entity of the plurality of entities;
determining that the bid from the recipient entity is a winning bid;
modifying the return message to summarize the winning bid; and
determining to send the return message that was modified to the another recipient.

12. The method of claim 8, wherein sending the return message comprises:
determining that a predefined criteria related to the additional recipient entity or the entity outside of the conversation has been met; and
in response to the determining, sending the return message to the additional recipient entity or the entity outside of the conversation.

13. The method of claim 8, wherein analyzing the return message comprises performing a lexical analysis on the return message to determine that the return message is to be sent to the additional recipient entity or the entity outside of the conversation.

14. A system for managing messaging within a conversation between an originating entity and a plurality of recipient entities, the system comprising:
a server comprising a communication module for sending and receiving messages associated with the conversation; and
a processor coupled to the server and configured to perform operations comprising;
detecting that each of the plurality of recipient entities has received an electronic message sent from the originating entity,
monitoring the receipt of the electronic message by each of the recipient entities to determine that the electronic message is to be sent to an additional recipient entity, and
based on the monitoring, sending the electronic message to the additional recipient entity.

15. The system of claim 14, wherein sending the electronic message to the additional recipient entity comprises:
removing the electronic message from an electronic Inbox of one of the plurality of recipient entities, and
forwarding the electronic message to an additional electronic inbox of the additional recipient entity.

16. The system of claim 14, wherein monitoring the receipt of the electronic message by each of the recipient entities comprises:
determining that one of the plurality of recipient entities has not viewed the electronic message, and
in response to the determining, identifying the additional recipient entity.

17. The system of claim 14, wherein monitoring the receipt of the electronic message by the recipient entity comprises:
determining that one of the recipient entities is not relevant to the electronic message, and
in response to the determining, identifying the additional recipient entity, wherein the additional recipient entity is relevant to the electronic message.

18. The system of claim 14, wherein sending the electronic message to the additional recipient entity comprises:
analyzing the electronic message to determine how to modify content associated with the electronic message,
modifying the content associated with the electronic message according to the analyzing, and
sending the electronic message with the content that was modified to the additional recipient entity.

19. The system of claim 14, wherein the processor is configured to perform operations further comprising:
detecting that the additional recipient entity has sent a return message to the originating entity,
analyzing the return message to determine that the return message is to be sent to a further recipient entity, and
in response to the analyzing, sending the return message to the further recipient entity.

20. The system of claim 14, wherein monitoring the receipt of the electronic message by each of the recipient entities comprises performing a lexical analysis on the electronic message to determine that the electronic message is to be sent to the additional recipient entity.
